SEQUENCE LISTING (6 sequences)

SEQ ID NO: 1 - protein, 317 aa, Candida antarctica [sequence omitted]

SEQ ID NO: 2 - protein, 19 aa, Artificial sequence
  Synthetic construct
SSKKSGSYSGSKGSKRRIL

SEQ ID NO: 3 - protein, 336 aa, Artificial sequence
  Synthetic construct
LPSGSDPAFSQPKSVLDAGLTCQGASPSSVSKPILLVPGTGTTGPQSFDSNWIPLSTQLGYTPCWISPPPFMLNDTQVNTEYMVNAITALYAGSGNNKLPVLTWSQGGLVAQWGLTFFPSIRSKVDRLMAFAPDYKGTVLAGPLDALAVSAPSVWQQTTGSALTTALRNAGGLTQIVPTTNLYSATDEIVQPQVSNSPLDSSYLFNGKNVQAQAVCGPLFVIDHAGSLTSQFSYVVGRSALRSTTGQARSADYGITDCNPLPANDLTPEQKVAAAALLAPAAAAIVAGPKQNCEPDLMPYARPFAVGKRTCSGIVTPSSKKSGSYSGSKGSKRRIL

SEQ ID NO: 4 - protein, 24 aa, Artificial sequence
  Synthetic construct
SSKKSGSYSGSKGSRRIRRRAREI

SEQ ID NO: 5 - protein, 12 aa, Artificial sequence
  Synthetic construct
MSPHPHPRHHHT

SEQ ID NO: 6 - protein, 12 aa, Artificial sequence
  Synthetic construct
LPHHHHLHTKLP

(19) United States
(12) Patent Application Publication
(10) Pub. No.: US 2012/0034338 A1
(43) Pub. Date: Feb. 9, 2012

(54) Enzyme with silaffin

(75) Inventors: Anne Mette Bhatia Frederiksen, Copenhagen (DK); Jesper Vind, Vaerloese (DK); Lars Saaby Pedersen, Farum (DK); Hans Peter Heldt-Hansen, Virum (DK); Marco Malten, Copenhagen (DK)

(73) Assignee: Novozymes A/S, Bagsvaerd (DK)

(21) Appl. No.: 13/259,807

(22) PCT Filed: Apr. 20, 2010
(86) PCT No.: PCT/EP2010/055189

§ 371 Date: Sep. 23, 2011

Related U.S. Application Data
(60) Provisional application No. 61/174,650, filed on May 1, 2009.

(30) Foreign Application Priority Data
Apr. 30, 2009 (EP) 09159213.9

(51) Int. Cl. A23L 2/70; A23C 9/12; A23L 2/02; C12G 1/00; C12C 7/175; C12C 7/14; A23L 2/72; A23L 2/80; C12C 7/16; C12C 11/00; C12C 7/00

(52) U.S. Cl. 426/15; 426/7; 426/11; 426/42; 426/51; 426/16

(57) ABSTRACT

A method of separating an enzyme construct from a solution, comprising providing an enzyme construct comprising an enzyme fused to a silaffin; adding the enzyme construct to a solution; adding a silica to the solution and separating the silica bound enzyme construct from the solution, wherein the solution is a beverage or a beverage intermediate.

### REFERENCE TO SEQUENCE LISTING

This application contains a Sequence Listing in computer readable form. The computer readable form is incorporated herein by reference.

### FIELD OF THE INVENTION

A method of removing enzymes from aqueous solutions using a fusion protein comprising a silaffin fused to an enzyme of interest. The enzyme could be any enzyme which is added to an aqueous solution such as a beverage. Most of the enzyme activity is retained and thus the enzyme could be reused.

### BACKGROUND OF THE INVENTION

Enzymes are often added to aqueous solutions in order to assist different chemical reactions. In most beverages enzymes are added to assist enzymes, which are already naturally present. Often these enzymes are unwanted in the final product and thus they have to be removed from the solution. It is specially preferred to have the enzymes removed by processes which are gentle and which preserve most of the enzyme activity. In that way the enzyme could be reused.

Various immobilisation processes are known and many of them concern the capturing the enzymes on an immobilized surface.

There are many ways of capturing enzymes, many of those destroy almost all the enzyme activity and/or are performed under harsh conditions such as high or low pH, high temperature etc. Such systems are clearly not suitable for beverages for human consumption.

A special way of immobilizing biomolecules, such as enzymes, is described by Luckarift et.al., Nature Biotechnology, Vol. 22, no 2, 2004: They describe the immobilization of enzymes by coprecipitation with silica. The document describes a biosilification reaction mixture consisting of silicic acid and a special silaffin peptide named R5 peptide with repeating unit H₂N—SSKKSGSYSGSKGSKRRIL-COOH, which is known to condense silica. The peptide, which is described in (Foo et al., 2006, PNAS, 103, p. 9428-9433) catalyses the precipitation of silica when silica acid is added. The R5 peptide was first identified from the diatom Cylindrotheca fusiformis.

The effectiveness of enzyme immobilization with silaffin R5 peptide and silicic acid is partly due to the mild condition, which minimises denaturation of the enzyme.

Most silaffins are highly post translationally modified peptides which may be derived from the Si11 protein of Cylindrotheca fusiformis. The peptides contain lysines which may be modified with long-chain poly amines and serines which may be phosphorylated. Thus the silaffins represent a zwitterionic structure with many positive and negative charges as described by Sumper et al. (Adv.Funct.Mater. 2006 Vol. 16, page 17-26). While silaffins effectively precipitate silica at mildly acid conditions the R5 peptide is capable of precipitating silica at neutral pH. Furthermore, the R5 peptide is not post translationally modified.

In US 2005/0095690 a method of immobilization of molecules in a silica matrix is described. The method comprises combining a silaffin polypeptide biomolecule and a hydroxylated water soluble silica derivative which may be silicic acid. The reaction result in formation of a solid silica matrix.

Thus a variety of methods for immobilization of proteins by attachment to silica/silicate surfaces or physical entrapment inside silica exist. However, such approaches are costly and still bear risk of denaturing of the protein. In addition, the use of silicic acid is unwanted in consumable aqueous solutions, such as beverage.

Kröger et. al. (Angew.Chem.Int.Ed. 2007, 46, 1843-1846) has instead used genetic manipulation to create a biological silica forming machinery and thereby enabled immobilization of a bacterial enzyme within the biosilica structures of a diatom, by entrapment during silica precipitation.

Foo et.al. (PNAS, Vol. 103. 2006 no. 25) has described a chimeric protein comprising the R5 peptide and a self assembly domain of a spider protein. The chimeric fusion protein is used for creation of silica nanocomposite formation, by precipitation of silica in solution.

Enzymes are often added to beverages such as beer, the exogenous enzymes complement or substitutes for the endogenous enzymes found in the grains e.g. barley used as raw material for beer. Enzymes are also added to juices to reduce the haze of the juice.

However, these added enzymes are unwanted in the final product and thus there is a need for gentle methods for removing these enzymes, and preferably in a way where the enzyme activity is retained, in order to enable the reuse of the enzyme.

### SUMMARY OF THE INVENTION

In one aspect, the present invention provides a method of separating an enzyme construct from a solution, comprising the following steps:
a) providing an enzyme construct comprising an enzyme fused to a silaffin;
b) adding the enzyme construct to a solution;
c) adding a silica to the solution before, during and/or after step b); and
d) separating the silica bound enzyme construct from the solution,
   wherein the solution is a beverage or a beverage intermediate.

In one aspect, the method is a processing step of making a beverage.

In another aspect, the solution comprises substrates for the enzymes.

In one aspect, the solution is alcoholic.

In another aspect, the solution is non alcoholic.

In one aspect, the invention provides polypeptide constructs comprising an enzyme fused to a silaffin, wherein the construct is capable of binding silica.

In another aspect, the present invention provides the use of construct comprising an enzyme linked to silaffin in beer production.

### DETAILED DESCRIPTION OF THE INVENTION

Enzymes are used in a variety of industrial processes including pulp and paper, detergents, textiles, food and beverages, bio-ethanol, leather processing etc. Usually in food and beverage production, enzymes that are naturally present in the food material or produced by the organism used for fermentation are used, for example, during malting of grains for beer production.

However in many situations and also in other industries, enzymes are added externally to complement the enzymes found naturally. Many of these enzymes are not needed or undesired in the final product and are preferably removed from the product by many means. For example, the enzymes are denatured by boiling or the enzymes are degraded using other enzymes. Though the use of enzymes is very effective to speed up reactions, make environment friendly production systems, cut costs of raw materials, cut production time etc, they may be expensive and use of these expensive enzymes may actually increase the cost of production to some extent. Hence it is preferable that these added enzymes are removed from the final product by some means, such that they can be reused. However, it is difficult to remove the soluble enzymes from liquid products in solution. One way of removing the enzymes is to make immobilized enzyme systems which retain the enzymes and prevent it from being removed along with the product. Other methods involve use of harsh conditions which result in enzyme precipitation. However use of such harsh conditions result in damage to the final products, particularly beverages, in terms of their quality and also sometimes affect the re-usability of the enzymes.

It is of interest to identify new methods for enzyme removal which do not affect the final product and also result in better enzyme re-usability.

Surprisingly, the inventors have found that by using enzyme constructs comprising enzymes fused to silaffins they can safely and effectively remove them from any solution.

In one aspect, the invention provides a method of separating an enzyme construct from a solution, comprising the following steps:
a) providing an enzyme construct comprising an enzyme fused to a silaffin;
b) adding the enzyme construct to a solution;
c) adding a silica to the solution before, during and/or after step b); and
d) separating the silica bound enzyme construct from the solution.
   wherein the solution is a beverage or a beverage intermediate.

The term “enzyme” has the conventional meaning in the art. The enzymes that could be used for this invention include Oxidoreductases, Transferases, Hydrolases, Lyases, Isomerases and Ligases. The enzymes can be starch degrading enzymes for example, but not limited to, amylases, beta-amylase, pullulanase or amyloglucosidases or combinations thereof. They could also be proteolytic enzymes, for example, but not limited to, endo and exo proteases. The enzymes could also be cellulolytic enzymes, for example but not limited to, cellulases, hemi cellulases, xylanases etc. In one aspect, the enzyme is Acetolactate Decarboxylase (ALDC). In another aspect, the enzyme is an amylase, including alpha or beta amylase. In one aspect, the enzyme is Amyloglucosidase (AMG). In another aspect, the enzyme is a beta glucosidase. In one aspect, the enzyme is a laccase, while in another aspect, the enzyme is a peroxidase. In one aspect, the enzyme is a lipase.

The term “enzyme construct” refers to a modified enzyme. The modification does not preferably affect the enzyme activity. However the invention may also include but not limited to modified enzymes that have an altered specific activity when compared to the non-modified enzymes.

The term “Silaffin” refers to silaffin polypeptides or their fragments or their synthetic derivatives. Silaffin polypeptides are polypeptides having affinity to silica. They were isolated originally from diatoms, which are unicellular algae that form a nanopatterned silica structure as a kind of skeleton. (Kröger et al., Science 286, 1129 (1999)). Silaffin polypeptides are known to be post translationally modified by long chain polyamines and also by phosphorylation, which are implicated in their role in silica affinity. However, non modified peptides also have been shown to have the ability to bind silica under appropriate conditions. The silaffins of the present invention can be either modified or un-modified or partially modified. In one aspect, the silaffin is a Sil1 protein, or a fragment or a synthetic derivative thereof capable of binding silica. In another aspect, the silaffin is a sil2 protein.

In a preferred embodiment according to the present invention the silaffin is a polypeptide selected from the group consisting of SEQ ID NO 2, SEQ ID NO 4, SEQ ID NO 5 and SEQ ID NO 6.

The phrase “enzyme fused to a silaffin” refers to the enzyme modified with one or more silaffins. The modification of the enzyme may be at the N terminal or at the C terminal or in between. The method of making fusion proteins is known in the art.

The term “solution” has the conventional meaning in the art. Preferably the solution is a liquid and preferably it is aqueous. In one aspect, the solution comprises substrates for the enzyme(s). In another aspect, the solution is the fermentation medium into which the enzyme(s) is secreted. In one aspect, the solution is alcoholic. In another aspect, the solution is non alcoholic. In one aspect, the solution itself can be a mixture of two or more solutions. In a preferred embodiment, the solution is beer. In one aspect, the solution is a beverage. In another aspect, the solution can also be a beverage intermediate or a beverage product.

The term “beverage” has the conventional meaning in the art. Examples of beverages include but are not limited to milk, juice, lemonade, chocolate milk, wine, beer, wort etc. The term “beverage intermediate” refers to a material formed during the process of manufacture of a beverage. Examples of beverage intermediates include but are not limited to wort, un-processed juice, un-processed beer, un-processed wine, un-processed milk etc. Sometimes, the beverage intermediate could itself be consumed and in such cases it can also be a “beverage”. The term “beverage product” refers to a material formed after the processing of a beverage. The beverage product might be a product with some qualities that are not found in the beverage, per se, when it is formed. Some of these qualities will render the beverage product more preferred than compared to the original beverage. Some of these qualities include but are not limited to improved taste, improved flavor, improved stability, clarity, improved filterability etc. The beverage product itself may be consumed and in such cases, it can also be a beverage. Sometimes, the beverage product may itself be a beverage intermediate during the process of manufacture of another beverage. Sometimes, a beverage intermediate may itself be a beverage product obtained after processing of a beverage.

The term “silica” has the conventional meaning in the art. The silica is preferably silicon di-oxide or its derivates. The silica may be of different forms, for example, amorphous or crystalline. The silica may also be different commercially available forms of silica. In one aspect, the silica is a porous form of silica made synthetically by precipitation from a silica solution. In another aspect, the silica is biosilica, obtained from diatoms. In one aspect, the silica is synthetic silica. In another aspect, the silica is Kieselguhr, a form of silica composed of the siliceous shells of unicellular aquatic plants of microscopic size. In one aspect, the silica is precipitated silica, prepared by the reaction of a silica solution with acid. The silica used can also be a mixture of two or more types of silica.

In one aspect, the silica and/or silica bound enzyme construct is separated by centrifugation, filtration and/or precipitation or combinations thereof.

In one aspect, the method of the invention is a processing step in making of a beverage, preferably a brewing process, more preferably the fermentation or maturation of beer.

In another aspect, the method of the invention is a step for concentration of the enzyme from a dilute solution. The enzymes from a dilute solution are separated out from the solution by means of silica binding and the precipitate is reconstituted into a higher concentration solution. Once separated out from the solution, the silica bound enzyme construct can be separated from the bound silica by means known in the art.

In another aspect, the invention provides a polypeptide construct comprising an enzyme fused to a silaffin, wherein the construct is capable of binding silica.

In yet another aspect, the present invention provides the use of construct(s) comprising an enzyme linked to a silaffin in beer production.

The use of these constructs in beverage production especially beer is advantageous since it results in easy and safe removal of the added enzymes from the beer. The use of these constructs and their method of removal do not adversely affect the beer product in any way, for example in terms of flavor, taste etc.

In a specially preferred embodiment of the invention the method according to the invention is used for removing enzymes containing a silica binding domain (silaffin) from the wort or green beer where the enzyme containing a silica binding domain has been added after the wort boiling step, which is not possible today because of lack of acceptance of enzymes being present in the final beer.

### EXAMPLES

### Example 1

### Lipase Adsorption to Silica—Effect of Silaffin Peptide Extension on C-Terminal

The addition of a silaffin peptide extension to an enzyme protein enhances the enzyme adsorption to a silica particle. The objective of this example is to give an example of this. The effect of adding a silaffin peptide extension to B lipase from Candida antarctica is demonstrated in an experiment where the two variants of the enzyme are adsorbed at equal conditions to precipitated silica particles.

As a reference enzyme without silaffin extension is used the B lipase from Candida antarctica (SEQ ID NO 1). The silaffin containing enzyme is the B lipase from Candida antarctica with the R5 silaffin peptide (amino acid sequence: SSKKSGSYSGSKGSKRRIL) attached to the C-terminus lipase. The amino acid sequence of the R5 silaffin is given in SEQ ID NO 2. The sequence of the silaffin containing lipase is given in SEQ ID NO 3.

The precipitated silica used for the adsorption experiments is Sipernat 22S, which is a commercially available product from Evonik Industries, Germany.

Both enzymes were dissolved in a 50 mM MES-buffer (2-[N-Morpholino]ethanesulfonic acid hydrate) at pH 7.0 in concentrations from 50 to 375 mg/l. Precipitated silica is added to the enzyme solution in an silica to solution mass ratio of 1 to 10.

After a holding time of 15 minutes at 25° C. with constant shaking, a sample of the liquid phase was collected and filtered in order to remove the silica. The amount of non adsorbed protein in the solution was determined by the BCA method (BCA Protein Assay kit, Thermo Fisher Scientific), and the amount of protein adsorbed was calculated.

| | Protein concentration in the super- | | Protein adsorbed on the carrier [mg | |
|---|---|---|---|---|
| Protein concen- | natant after adsorption [mg/l] | | enzyme protein per g silica] | |
| tration at start | Reference with- | Product with | Reference with- | Product with |
| [mg/l] | out silaffin extension | silaffin extension | out silaffin extension | silaffin extension |
| 100 | 34 | 0 | 0.66 | 1 |
| 200 | 118 | 0 | 0.82 | 2 |
| 300 | 204 | 7 | 0.96 | 2.9 |
| 375 | 296 | 20 | 0.79 | 3.6 |

The data shows that the lipase having a silaffin peptide extension at the C-terminal has a much stronger adsorption affinity to the precipitated silica than the lipase enzyme without C-terminal extension.

1. A method of separating an enzyme construct from a solution, comprising the following steps:
a) providing an enzyme construct comprising an enzyme fused to a silaffin;
b) adding the enzyme construct to a solution;
c) adding a silica to the solution before, during and/or after step b); and
d) separating the silica bound enzyme construct from the solution;
wherein the solution is a beverage or beverage intermediate.

2. The method according to claim 1, wherein the solution is an aqueous solution.

3. The method according to claim 1, wherein the enzyme is selected from the group consisting of oxidoreductases, transferases, hydrolases, lyases, isomerases and ligases.

4. The method according to claim 1, wherein the enzyme is selected from the group consisting of acetolactate decarboxylases (ALDC), alpha amylases, beta amylases, beta glucosidases, amyloglucosidases (AMG), proteases, lipases, laccases and peroxidases.

5. The method according to claim 1, wherein the silaffin is a SiL1 protein or a fragment thereof or a synthetic derivative capable of binding silica.

6. The method according to claim 1, wherein the silaffin has the amino acid sequence selected from the group consisting of SEQ ID NO 2, SEQ ID NO 4, SEQ ID NO 5 and SEQ ID NO 6.

7. The method according to claim 1, wherein the silica is selected from the group consisting of biosilica, synthetic silica, amorphous silica, silica gel, kiesel guhr and precipitated silica.

8. The method according to claim 1, wherein the method is a processing step of making a beverage.

9. The method according to claim 1, wherein the beverage is selected from the group consisting of beer, milk, juice, lemonade, chocolate milk, wine and wort.

10. The method according to claim 1, wherein the silica bound enzyme construct is separated by centrifugation and/or filtration.

11. (canceled)
